(19) United States
(12) Patent Application Publication
(10) Pub. No.: US 2026/0178259 A1
(43) Pub. Date: Jun. 25, 2026

(54) VISUAL SOUND EFFECT ADJUSTMENT METHOD AND PROGRAM

(71) Applicant: PRIMAX ELECTRONICS LTD., Taipei City (TW)

(72) Inventors: SHYH-YAW JOU, Taipei City (TW); CHUNG-HAN CHEN, Taipei City (TW); CHANG-YUNG FENG, Taipei City (TW); YEN-TING CHEN, Taipei City (TW); HUNG-TE TU, Taipei City (TW); SHENG-LING HUANG, Taipei City (TW); JUI-JEN CHENG, Taipei City (TW)

(21) Appl. No.: 19/032,464

(22) Filed: Jan. 21, 2025

(30) Foreign Application Priority Data
Dec. 20, 2024 (TW) 113149782

(51) Int. Cl. G06F 3/16; A63F 13/54; G06F 3/04817

(52) U.S. Cl. CPC G06F 3/165; A63F 13/54; G06F 3/04817

(57) ABSTRACT

A visual sound effect adjustment method for a computing device is provided. A visual sound effect adjustment program is executed to perform the visual sound effect adjustment method. Firstly, a first audio signal is acquired. Then, a first sound element contained in the first audio signal is recognized, and a first representative icon and a first volume setting icon corresponding to the first sound element are displayed. Then, a judging step is performed to judge whether a volume setting of the first sound element needs to be adjusted. After the volume setting of the first sound element is adjusted, a second audio signal is captured, and the first sound element is extracted from the second audio signal. Then, the second audio signal is reproduced, and the adjusted first sound element is added to the second audio signal.

### FIELD OF THE INVENTION

The present invention relates to a sound effect adjustment method, and more particularly to a sound effect adjustment method for visually presenting the sound elements in the audio signals and correspondingly setting the volume.

### BACKGROUND OF THE INVENTION

When a computing device is used to execute a computer program related to the sound output effect, a problem usually occurs. For example, when a shooting game in a video game program is executed, sometimes the user cannot clearly hear the sound element of the footsteps in the output sound effect. Since the user cannot determine when to shoot or whether the enemy is approaching, the user usually miss the best reaction time. Meanwhile, if the user turns up the overall volume of the video game to clearly hear the enemy's footsteps, some drawbacks occur. For example, although the volume of the footsteps becomes louder, the volume of other sound elements is also amplified at the same time. After a long use time, the user's hearing will be adversely affected.

In accordance with another approach, a digital equalizer (EQ). is used to adjust the sound effect. According to the adjustment principle of the equalizer, the audio signal is divided into a plurality of frequency bands for facilitating the user to self-adjust the gain value corresponding to a specific frequency band. However, since each sound element may cover a plurality of frequency bands, it is difficult for non-professional users to remember the frequency band corresponding to each sound element. In other words, the conventional technologies are not easy to meet the needs of users.

### SUMMARY OF THE INVENTION

The present invention provides a visual sound effect adjustment method. When a visual sound effect adjustment program is executed, the visual sound effect adjustment method is performed. In accordance with a feature of the present invention, the sound element contained in the audio signal is individually recognized, and various sound elements are displayed through the visualized icons. In addition, the intuitive sound adjustment design is also added. When the computing device executes the computer program to output the audio signal, the user can quickly realize which sound elements in the audio signal can be adjusted. In addition, the user can directly perform the volume adjustment on the screen image without jumping out of the computer program. Consequently, the operating process and complexity will be simplified.

In accordance with an aspect of the present invention, a visual sound effect adjustment method for a computing device is provided. A visual sound effect adjustment program is executed to perform the visual sound effect adjustment method. The visual sound effect adjustment method includes the following step. Firstly, a first audio signal is acquired. Then, a first sound element contained in the first audio signal is recognized, and a first representative icon and a first volume setting icon corresponding to the first sound element are displayed. Then, a judging step is performed to judge whether a volume setting of the first sound element needs to be adjusted. After the volume setting of the first sound element is adjusted, a second audio signal is captured, and the first sound element is extracted from the second audio signal. Then, the second audio signal is reproduced, and the adjusted first sound element is added to the second audio signal.

In an embodiment, the first representative icon represents a weapon, an equipment, an action, an event, a character, a scene and a musical instrument.

In an embodiment, the first volume setting icon is a slider icon or a knob icon.

In an embodiment, the first representative icon and the first volume setting icon are displayed on a user operation interface.

In an embodiment, the user operation interface includes a touch screen, and a touch signal is generated when the first volume setting icon is operated through the touch screen. The volume setting of the first sound element is adjusted in response to the touch signal.

In an embodiment, the touch screen is a display screen of a notebook computer, a display screen of a tablet computer, a display screen of a mobile phone or a display screen of an audio control device.

In an embodiment, the user operation interface includes a display screen and a mouse, and the first representative icon, the first volume setting icon and a cursor of the mouse are displayed on the display screen. An input signal is generated when the first volume setting icon is operated through the mouse. The volume setting of the first sound element is adjusted in response to the input signal.

In an embodiment, the user operation interface includes a display screen and a touch pad, and the first representative icon, the first volume setting icon and a cursor of the touch pad are displayed on the display screen. An input signal is generated when the first volume setting icon is operated through the touch pad. The volume setting of the first sound element is adjusted in response to the input signal.

In accordance with another aspect of the present invention, a visual sound effect adjustment method for a computing device is provided. A visual sound effect adjustment program is executed to perform the visual sound effect adjustment method. The visual sound effect adjustment method includes the following step. Firstly, a first audio signal is acquired. Then, a first sound element and a second sound element contained in the first audio signal are recognized. Then, a first representative icon and a first volume setting icon corresponding to the first sound element and a second representative icon and a second volume setting icon corresponding to the second sound element are displayed. Then, a judging step is performed to judge whether a volume setting of the first sound element or a volume setting of the second sound element needs to be adjusted. After the volume setting of the first sound element or the volume setting of the second sound element is adjusted, a second audio signal is captured, and the first sound element and the second sound element are extracted from the second audio signal. Then, the second audio signal is reproduced, and the adjusted first sound element or the adjusted second sound element is added to the second audio signal.

In an embodiment, each of the first representative icon and the second representative icon represents a weapon, an equipment, an action, an event, a character, a scene and a musical instrument.

In an embodiment, each of the first representative icon and the second representative icon is a slider icon or a knob icon.

In an embodiment, the first representative icon, the first volume setting icon, the second representative icon and the second volume setting icon are displayed on a user operation interface.

In an embodiment, the user operation interface includes a touch screen, and a touch signal is generated when the first volume setting icon or the second volume setting icon is operated through the touch screen. The volume setting of the first sound element or the volume setting of the second sound element is adjusted in response to the touch signal.

In an embodiment, the touch screen is a display screen of a notebook computer, a display screen of a tablet computer, a display screen of a mobile phone or a display screen of an audio control device.

In an embodiment, the user operation interface includes a display screen and a mouse, and the first representative icon, the first volume setting icon and a cursor of the mouse are displayed on the display screen. An input signal is generated when the first volume setting icon or the second volume setting icon is operated through the mouse. The volume setting of the first sound element or the second volume setting icon is adjusted in response to the input signal.

In an embodiment, the user operation interface includes a display screen and a touch pad, and the first representative icon, the first volume setting icon, the second representative icon, the second volume setting icon and a cursor of the touch pad are displayed on the display screen. An input signal is generated when the first volume setting icon or the second volume setting icon is operated through the touch pad. The volume setting of the first sound element or the volume setting of the second sound element is adjusted in response to the input signal.

In accordance with another aspect of the present invention, a visual sound effect adjustment method for a computing device is provided. A visual sound effect adjustment program is executed to perform the visual sound effect adjustment method. The visual sound effect adjustment method includes the following step. Firstly, a first audio signal is acquired. Then, a first sound element and a second sound element contained in the first audio signal are recognized. Then, a usage scenario containing the first sound element and the second sound element is acquired. Then, a representative icon corresponding to the usage scenario is displayed.

In an embodiment, the representative icon is a pattern, a text, or a combination thereof.

In an embodiment, a type of the usage scenario is a music, a movie or a video game.

In an embodiment, the video game is a shooting game, an action game, a fighting game, an adventure game, a role-playing game, a strategy game, a simulation game, a racing game, a sports game, a music game or a puzzle game.

In accordance with another aspect of the present invention, a visual sound effect adjustment method for a computing device is provided. A visual sound effect adjustment program is executed to perform the visual sound effect adjustment method. The visual sound effect adjustment method includes the following step. Firstly, a first audio signal and a first screen image are outputted, wherein the first audio signal contains a first sound element. Then, a first representative icon and a first volume setting icon corresponding to the first sound element are displayed on the first screen image. Then, a judging step is performed to judge whether a volume setting of the first sound element needs to be adjusted. After the volume setting of the first sound element is adjusted, a second audio signal and a second screen image are outputted. The second audio signal contains the first sound element. The first sound element is outputted according to the adjusted volume setting when the second audio signal is outputted.

In an embodiment, the first representative icon represents a weapon, an equipment, an action, an event, a character, a scene and a musical instrument.

In an embodiment, the first volume setting icon is a slider icon or a knob icon.

In an embodiment, the first representative icon and the first volume setting icon are displayed on a user operation interface.

In an embodiment, the user operation interface includes a touch screen, and a touch signal is generated when the first volume setting icon is operated through the touch screen. The volume setting of the first sound element is adjusted in response to the touch signal.

In an embodiment, the touch screen is a display screen of a notebook computer, a display screen of a tablet computer, a display screen of a mobile phone or a display screen of an audio control device.

In an embodiment, the user operation interface includes a display screen and a mouse, and the first representative icon, the first volume setting icon and a cursor of the mouse are displayed on the display screen. An input signal is generated when the first volume setting icon is operated through the mouse. The volume setting of the first sound element is adjusted in response to the input signal.

In an embodiment, the user operation interface includes a display screen and a touch pad, and the first representative icon, the first volume setting icon and a cursor of the touch pad are displayed on the display screen. An input signal is generated when the first volume setting icon is operated through the touch pad. The volume setting of the first sound element is adjusted in response to the input signal.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a flowchart of a visual sound effect adjustment method according to a first embodiment of the present invention;

FIG. 2 schematically illustrates a game initialization screen when a shooting game is executed;

FIG. 3 schematically illustrates a game screen image, in which a first representative icon and a first volume setting icon are displayed when the shooting game is executed;

FIG. 4 schematically illustrates another game screen image after the volume setting of a first sound element has been adjusted;

FIG. 5 schematically illustrates another game screen image showing that the volume setting of the first sound element is helpful for playing the shooting game when the shooting game is executed;

FIG. 6 is a flowchart of a visual sound effect adjustment method according to a second embodiment of the present invention;

FIG. 7 schematically illustrates a game screen image, in which a first representative icon, a first volume setting icon, a second representative icon and a second volume setting icon are displayed when a shooting game is executed;

FIG. 8 is a flowchart of a visual sound effect adjustment method according to a third embodiment of the present invention;

FIG. 9 schematically illustrates a game screen image, in which a representative icon corresponding to a usage scenario is also displayed when a shooting game is executed; and

FIG. 10 is a flowchart of a visual sound effect adjustment method according to a fourth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a visual sound effect adjustment method. The visual sound effect adjustment method is performed through the execution of a visual sound effect adjustment program. When the visual sound effect adjustment program is executed in a computing device, a visual sound effect adjustment interface is provided to the user.

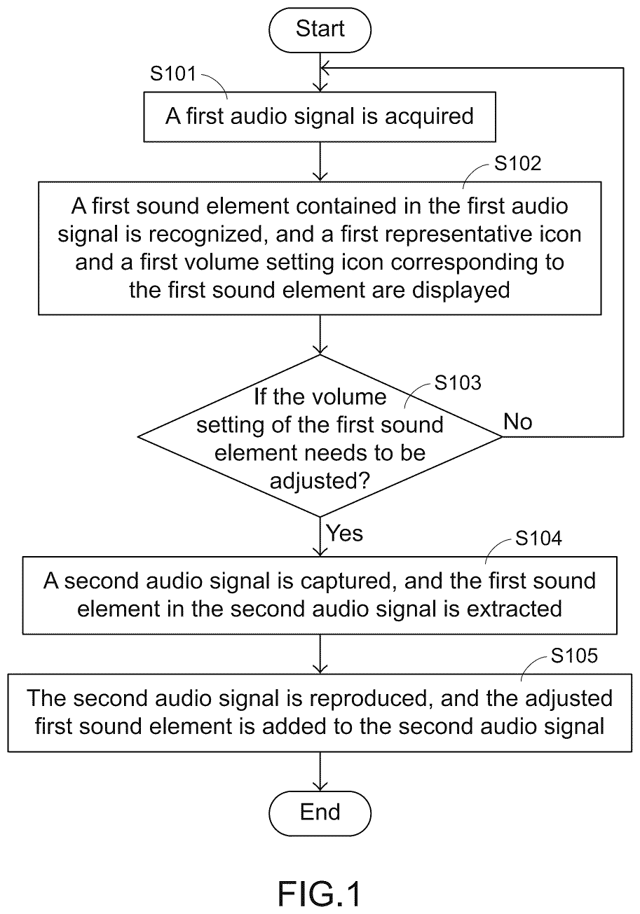

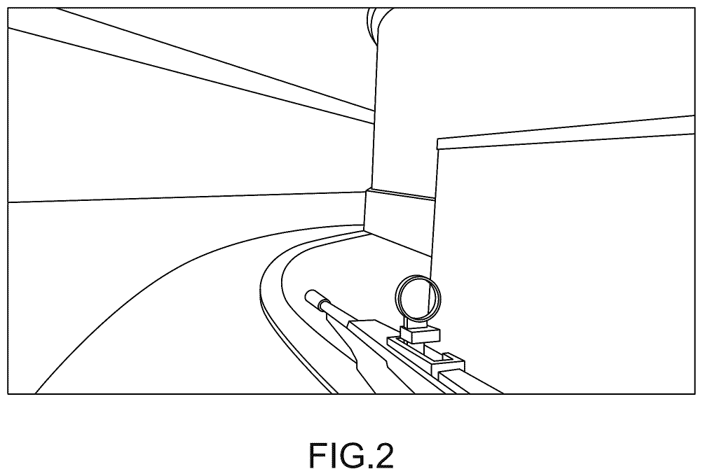

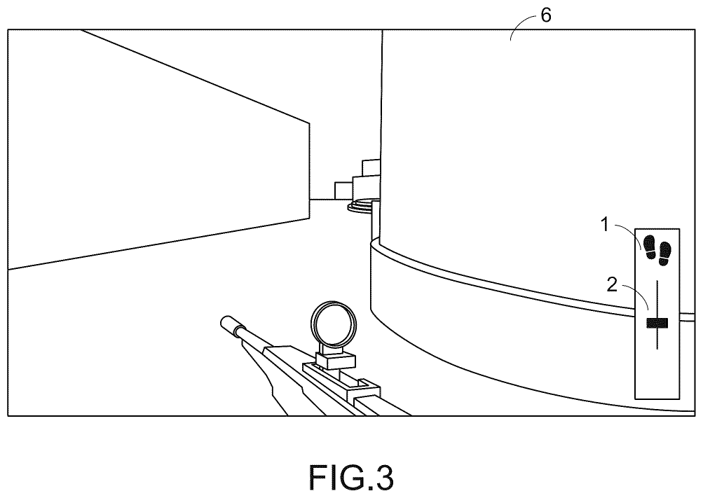

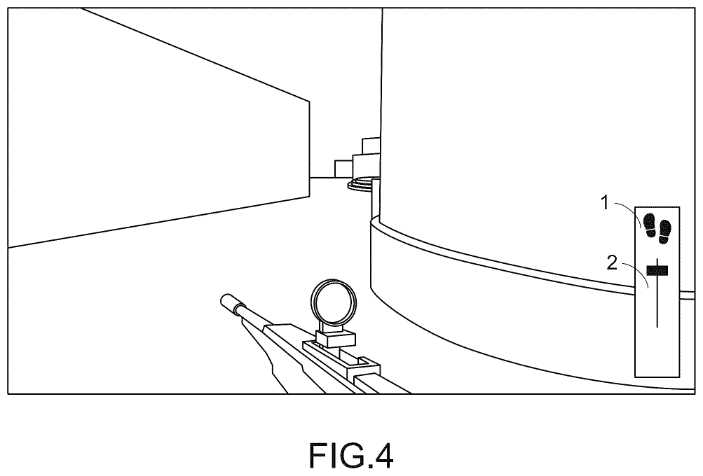

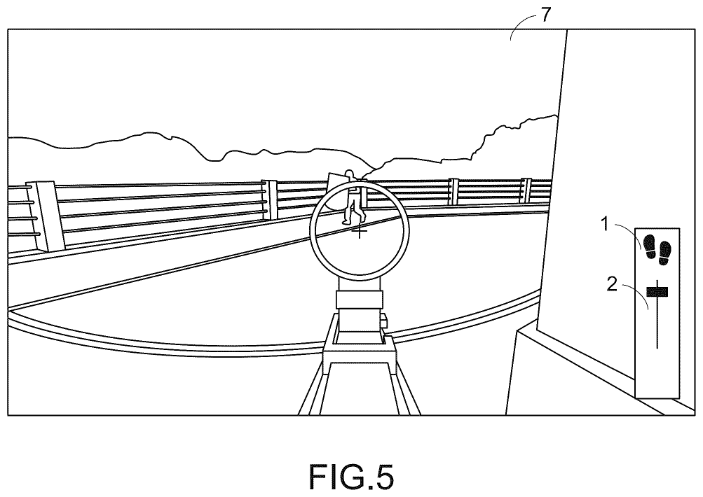

FIG. 1 is a flowchart of a visual sound effect adjustment method according to a first embodiment of the present invention. FIG. 2 schematically illustrates a game initialization screen when a shooting game is executed. FIG. 3 schematically illustrates a game screen image, in which a first representative icon and a first volume setting icon are displayed. FIG. 4 schematically illustrates another game screen image after the volume setting of a first sound element has been adjusted. FIG. 5 schematically illustrates another game screen image showing that the volume setting of the first sound element is helpful for playing the shooting game when the shooting game is executed. In FIGS. 2, 3, 4 and 5, a process of executing a shooting game program will be illustrated for well understanding the operations of the visual sound effect adjustment method and the visual sound effect adjustment program. It is noted that the applications of the visual sound effect adjustment method and the visual sound effect adjustment program are not restricted to the process of executing the shooting game program.

In this embodiment, the visual sound effect adjustment method includes the following steps.

Firstly, in a step S101, a first audio signal is acquired. In an embodiment, an audio signal is generated or outputted when the computing device executes a computer program. Meanwhile, the visual sound effect adjustment program acquires a segment from the audio signal for analysis. For example, the computer program is a video game program, a video/audio player program, a communication program, or any other appropriate sound-related computer program.

When a shooting game program is executed on the computing device, various audio signals are outputted according to the storyline arrangement of the shooting game program. In addition, the audio signals contain many sound elements, e.g., the sound elements representing various weapons, equipment, actions, events, characters, scenes, and musical instruments. These sound elements appear or disappear according to preset rules.

Then, in a step S102, a first sound element contained in the first audio signal is recognized, and a first representative icon and a first volume setting icon corresponding to the first sound element are displayed.

In accordance with the visual sound effect adjustment method of the present invention, the first sound element can be recognized from an outputted audio signal when the shooting game program is executed. For example, a sound element of footsteps is recognized. Then, the first representative icon and the first volume setting icon corresponding to the footstep sound are displayed on a user operation interface for allowing the user to adjust the volume. Please refer to FIG. 2 and FIG. 3. If the sound element of footsteps contained in the audio signal is recognized in the process of playing the shooting game, a first representative icon 1 with the picture of two feet soles is displayed to represent the sound element of footsteps, and a slider icon is displayed near the first representative icon 1 (i.e., the icon with the picture of two feet soles). This slider icon is the first volume setting icon 2 for allowing the user to adjust the volume of the sound element of footsteps. Since the slider icon is a common icon design for adjusting parameters, the user can intuitively increase the volume setting of the footsteps by sliding the slider icon upward or reduce the volume setting of the footsteps by sliding the slider icon downward.

In this embodiment, the icon with the picture of two feet soles is used to represent the sound element of footsteps in the shooting game. In some other embodiments, when a video game program, a video/audio player program, a communication program or any other appropriate sound-related computer program is executed, the icons that are helpful for visually recognizing various weapons, equipment, actions, events, characters, scenes or musical instruments can be used for allowing the user to understand various sound elements in the audio signals.

As mentioned above, the slider icon is an example of the volume setting icon that is located near the representative icon of the sound element and cooperates with the representative icon. It is noted that the example of the volume setting icon is not restricted. For example, in some other embodiments, the volume setting icon is a knob icon, a plus sign (+), a minus sign (−), a color-changeable icon or any other visual icon.

Then, a step S103 is performed to judge whether the volume setting of the first sound element needs to be adjusted.

In this embodiment, the user operation interface for displaying the first representative icon 1 and the first volume setting icon 2 is a touch screen. For example, the touch screen is a display screen of a notebook computer, a display screen of a tablet computer, a display screen of a mobile phone or a display screen of an audio control device. When the user wants to change the volume setting of the first sound element, the user can directly touch the first volume setting icon 2 on the touch screen to adjust the volume setting of the first sound element. On the contrary, if the user does not want to adjust the volume setting of the first sound element, the original volume setting can be retained. Furthermore, when the first volume setting icon 2 is operated by the user, a touch signal is generated. After the touch signal is received by the touch screen, the volume setting of the first sound element representing the footsteps will be adjusted. For example, as shown in FIG. 3 and FIG. 4, the volume setting of the first sound element representing the footsteps is increased after the slider icon of the first volume setting icon 2 is slid upward to generate the touch signal. In this way, as shown in FIG. 5, the user can hear the enemy's footsteps more easily. Furthermore, the user will be alerted or make corresponding preparations in advance.

Similarly, if the slider icon of the first volume setting icon 2 is slid downward and the corresponding touch signal is received by the touch screen, the visual sound adjustment program is notified to lower down the volume setting of the first sound element representing the footsteps.

In some other embodiments, the user operation interface for displaying the first representative icon 1 and the first volume setting icon 2 includes a display screen and a mouse. The first representative icon 1, the first volume setting icon 2 and the mouse cursor are displayed on the display screen. Similarly, the visual sound effect adjustment method of this embodiment further includes a step of receiving an input signal from the mouse. For example, the input signal is a displacement signal or a scroll wheel signal. When the first volume setting icon 2 is operated by the user through the mouse, the volume setting of the first sound element is adjusted in response to the input signal.

In some other embodiments, the user operation interface includes a display screen and a touch pad. The first representative icon 1, the first volume setting icon 2 and the touch pad cursor are displayed on the display screen. Similarly, the visual sound effect adjustment method of this embodiment further includes a step of receiving an input signal from the touch pad. For example, the input signal is a displacement signal or an up/down scrolling signal. When the first volume setting icon 2 is operated by the user through the touch pad, the volume setting of the first sound element is adjusted in response to the input signal.

After the volume setting of the first sound element is adjusted, a step S104 is performed. In the step S104, a second audio signal is acquired, and the first sound element in the second audio signal is extracted.

Furthermore, when the computing device executes the computer program and the audio signal is outputted, the visual sound effect adjustment program extracts a segment (e.g., the first audio signal) from the audio signal for analysis. After the first sound element is recognized, a visual volume adjustment mechanism interface is provided for allowing the user to adjust the volume setting of the first sound element. After the volume setting of the first sound element is adjusted, the visual sound effect adjustment program will capture the audio signal (e.g., the second audio) that is continuously outputted from the computing device when the computer program is executed. In addition, after the first sound element in the second audio signal is extracted, the volume setting of the first sound element is updated.

Then, in a step S105, the second audio signal is reproduced, and the adjusted first sound element is added to the second audio signal.

As mentioned above, the visual sound effect adjustment program reproduces the second audio signal. After the volume setting is adjusted, the adjusted first sound element is added to the second audio signal. With the help of the visual sound effect adjustment program, the second audio signal that meets the user's needs will be outputted when the computing device executes the computer program (e.g., the shooting game). The second audio signal that meets the user's needs contains the footstep sound with a higher volume.

In the visual sound effect adjustment method of the first embodiment, the volume setting is adjusted after the first sound element contained in the first audio signal is recognized. It is noted that numerous modifications and alterations may be made while retaining the teachings of the invention. For example, in some other embodiments, a plurality of sound elements are sequentially recognized, and corresponding volume setting icons are displayed for the user to select and operate.

The present invention further provides a visual sound effect adjustment method according to a second embodiment. The operations of the second embodiment are substantially identical to those of the first embodiment. Consequently, the descriptions and structures of the first embodiment can be adopted. In comparison with the first embodiment, the visual sound effect adjustment method of the second embodiment can recognize a plurality of sound elements and display the corresponding representative icons and volume setting icons.

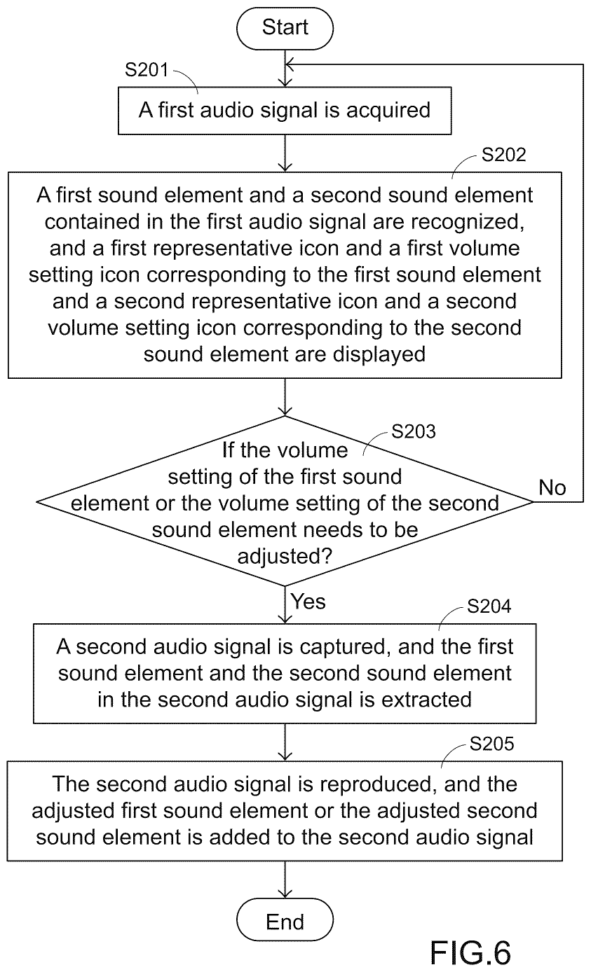

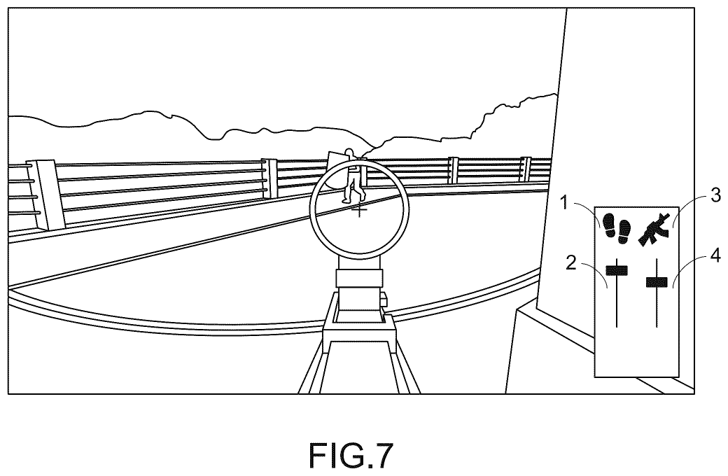

FIG. 6 is a flowchart of a visual sound effect adjustment method according to a second embodiment of the present invention. FIG. 7 schematically illustrates a game screen image, in which a first representative icon, a first volume setting icon, a second representative icon and a second volume setting icon are displayed when a shooting game is executed. Similarly, the visual sound effect adjustment method of this embodiment is performed through the execution of a visual sound effect adjustment program. When the visual sound effect adjustment program is used to execute the shooting game in a computing device, a first representative icon, a first volume setting icon, a second representative icon and a second volume setting icon are display on a game screen image.

In this embodiment, the visual sound effect adjustment method includes the following steps.

Firstly, in a step S201, a first audio signal is acquired.

Then, in a step S202, a first sound element and a second sound element in the first audio signal are recognized. In addition, a first representative icon 1 and a first volume setting icon 2 corresponding to the first sound element and a second representative icon 3 and a second volume setting icon 4 corresponding to the second sound element are displayed.

Then, a step S203 is performed to judge whether the volume setting of the first sound element or the volume setting of the second sound element needs to be adjusted

After the volume setting of the first sound element or the volume setting of the second sound element is adjusted, a step S204 is performed. In the step S204, a second audio signal is acquired, and the first sound element and the second sound element in the second audio signal is extracted.

Then, in a step S205, the second audio signal is reproduced, and the adjusted first sound element or the adjusted second sound element is added to the second audio signal.

In the visual sound effect adjustment method of the second embodiment, at least two sound elements are first recognized, then the scenario types corresponding to the at least two sound elements are recognized, and then the corresponding representative icons are displayed.

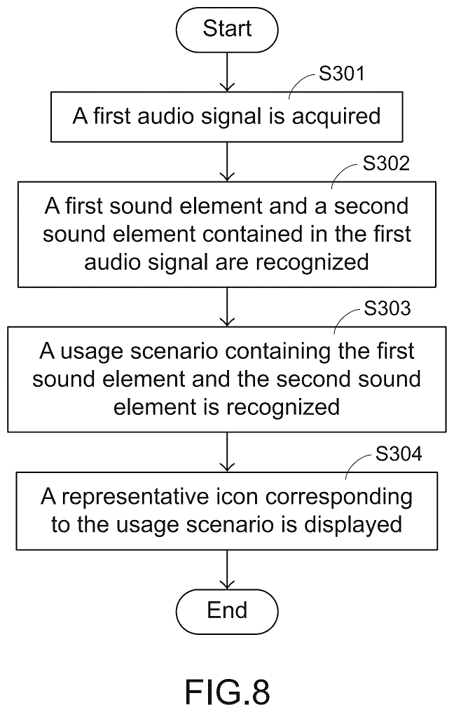

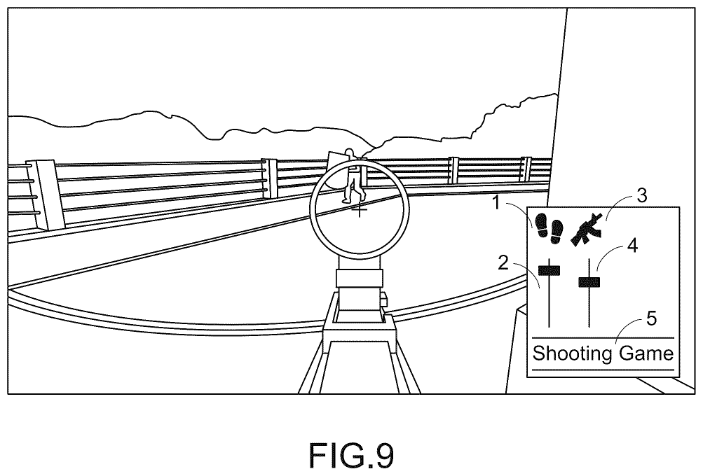

FIG. 8 is a flowchart of a visual sound effect adjustment method according to a third embodiment of the present invention. FIG. 9 schematically illustrates a game screen image, in which a representative icon corresponding to a usage scenario is also displayed when a shooting game is executed. Similarly, the visual sound effect adjustment method of this embodiment is performed through the execution of a visual sound effect adjustment program. When the visual sound effect adjustment program is used to execute the shooting game in a computing device, a representative icon corresponding to a usage scenario is also displayed on a game screen image.

In this embodiment, the visual sound effect adjustment method includes the following steps.

Firstly, in a step S301, a first audio signal is acquired.

Then, in a step S302, a first sound element and a second sound element contained in the first audio signal are recognized.

In a step S303, a usage scenario containing the first sound element and the second sound element is recognized.

In a step S304, a representative icon corresponding to the usage scenario is displayed.

In this embodiment, the representative icon corresponding to the usage scenario is a pattern, a text, or a combination thereof. For example, the representative icon 5 shown in FIG. 9 is the text “Shooting Game”.

The type of the usage scenario is selected from one of a music, a movie and a video game. The video game is a shooting game, an action game, a fighting game, an adventure game, a role-playing game, a strategy game, a simulation game, a racing game, a sports game, a music game, a puzzle game, or any other appropriate game type.

In this embodiment, the visual sound adjustment method displays the usage scenario for allowing the user to understand what computer program is currently being executed by the computer and allowing the user to recall the volume settings of various sound elements in various usage scenarios. Furthermore, the visual sound adjustment method includes a step of storing the volume settings of various sound elements in various usage scenarios.

In accordance with this customized memory function, the user's adjustment histories about the volume settings of specified sound elements in various usage scenarios will be recorded. Once one usage scenario is switched to another usage scenario, the previously stored volume adjustment history can be applied, and the user does not need to repeatedly set the volume of the sound element.

In the visual sound adjustment method of the first embodiment and the second embodiment, a sound effect (e.g., a first sound effect) is acquired to analyze the sound elements contained therein when the computing device executes the computer program. If the volume setting of a specified sound element has been adjusted, another sound effect (e.g., a second sound effect) is acquired and reproduced for output. Meanwhile, the sound element with the adjusted volume setting is added. In some other embodiments, the computer program is also a visual sound effect adjustment program and has the function of visual sound effect adjustment. That is, the computer program can accept the user's adjustment for the volume setting of the sound element. Consequently, it is not necessary to capture the sound effect and re-produce it for output.

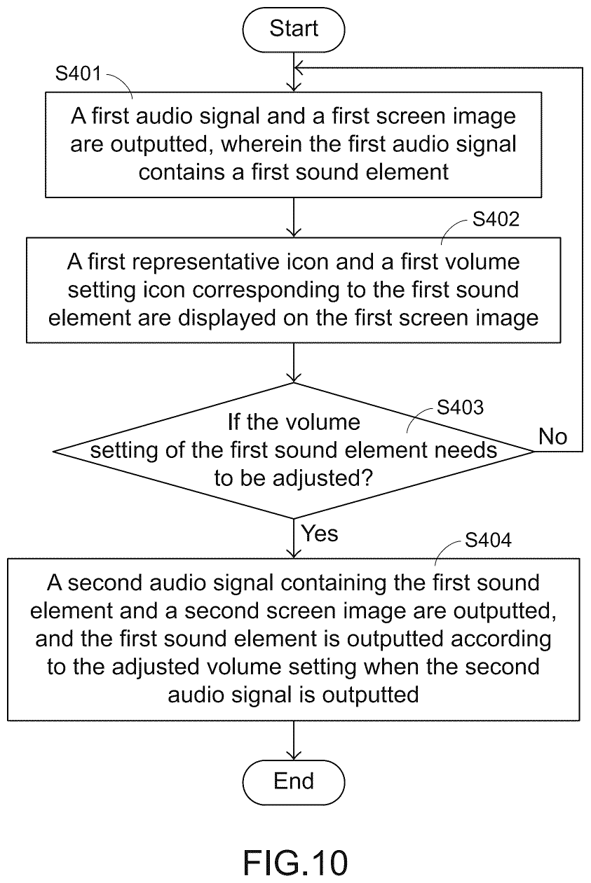

FIG. 10 is a flowchart of a visual sound effect adjustment method according to a fourth embodiment of the present invention. Similarly, the visual sound effect adjustment method of this embodiment is performed through the execution of a visual sound effect adjustment program. When the visual sound effect adjustment program is used to execute the shooting game in a computing device, the visual sound effect adjustment method is performed. The game screen image of the shooting game shown in FIGS. 2, 3 and 4 can be applied to the flowchart of FIG. 10.

Firstly, in a step S401, a first audio signal and a first screen image are outputted, wherein the first audio signal contains a first sound element.

In an embodiment, the first audio signal and the first screen image an audio signal are generated or outputted when the computing device executes a computer program. For example, the computer program is a video game program, a video/audio player program, a communication program, or any other appropriate sound-related computer program.

When a shooting game program is executed on the computing device, various audio signals are outputted according to the storyline arrangement of the shooting game program. In addition, the audio signals contain many sound elements, e.g., the sound elements representing various weapons, equipment, actions, events, characters, scenes, and musical instruments. These sound elements appear or disappear according to preset rules.

Then, in a step S402, a first representative icon and a first volume setting icon corresponding to the first sound element are displayed on the first screen image.

If the audio signal contains the sound elements for allowing the user to adjust the volume when the computing device executes the computer program, for example, the footstep sound, the gunshot sound, the explosion sound or other sound element appears in the process of playing the shooting game, the representative icon and the volume setting icon corresponding to the sound element are displayed on the user operation interface of the computing device. For example, as shown in FIG. 3, the first representative icon 1 representing the sound element of footsteps and the first volume setting icon 2 are displayed on the first screen image 6 shown in FIG. 3 for allowing the user to adjust the volume of the sound element.

Like the first embodiment and the second embodiment, the icons that are helpful for visually recognizing various weapons, equipment, actions, events, characters, scenes or musical instruments can be used for allowing the user to understand various sound elements in the audio signals. It is noted that the example of the volume setting icon is not restricted to the slider icon. For example, in some other embodiments, the volume setting icon is a knob icon, a plus sign (+), a minus sign (−), a color-changeable icon or any other visual icon.

Then, a step S403 is performed to judge whether the volume setting of the first sound element needs to be adjusted.

The detailed procedures of the step S403 are similar to those of the step S103 in the first embodiment, and not redundantly described herein. After the volume setting of the first sound element is adjusted, a step S404 is performed. In the step S404, a second audio signal containing the first sound element and a second screen image are outputted, and the first sound element is outputted according to the adjusted volume setting when the second audio signal is outputted.

After the user adjusts the volume setting of the first sound element, if the computing device subsequently or continuously executes the computer program, the computing device will generate or output the second audio signal and the second screen image 7. If the second audio contains the first sound element, the first sound element will be outputted according to the adjusted volume setting. It is noted that the number of sound elements to be adjusted is not restricted. For example, the representative icons and the volume setting icons correspond to a plurality of sound elements can be simultaneously or successively displayed on the user operation interface for the user to adjust.

From the above descriptions, the present invention provides the visual sound effect adjustment method and the visual sound effect adjustment program using this method. When the computing device executes the computer program, the sound element and the volume setting corresponding to the audio signal are displayed with visual icons. Consequently, the user can quickly and intuitively adjust the volume of the sound element without jumping out of the running screen.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A visual sound effect adjustment method for a computing device, a visual sound effect adjustment program being executed to perform the visual sound effect adjustment method, the visual sound effect adjustment method comprising steps of:
acquiring a first audio signal;
recognizing a first sound element contained in the first audio signal, and displaying a first representative icon and a first volume setting icon corresponding to the first sound element;
judging whether a volume setting of the first sound element needs to be adjusted;
capturing a second audio signal after the volume setting of the first sound element is adjusted, and extracting the first sound element from the second audio signal; and
reproducing the second audio signal, and adding the adjusted first sound element to the second audio signal.

2. The visual sound effect adjustment method according to claim 1, wherein the first representative icon represents a weapon, an equipment, an action, an event, a character, a scene and a musical instrument.

3. The visual sound effect adjustment method according to claim 1, wherein the first volume setting icon is a slider icon or a knob icon.

4. The visual sound effect adjustment method according to claim 1, wherein the first representative icon and the first volume setting icon are displayed on a user operation interface.

5. The visual sound effect adjustment method according to claim 4, wherein the user operation interface includes a touch screen, and a touch signal is generated when the first volume setting icon is operated through the touch screen, wherein the volume setting of the first sound element is adjusted in response to the touch signal.

6. The visual sound effect adjustment method according to claim 5, wherein the touch screen is a display screen of a notebook computer, a display screen of a tablet computer, a display screen of a mobile phone or a display screen of an audio control device.

7. The visual sound effect adjustment method according to claim 4, wherein the user operation interface includes a display screen and a mouse, and the first representative icon, the first volume setting icon and a cursor of the mouse are displayed on the display screen, wherein an input signal is generated when the first volume setting icon is operated through the mouse, and the volume setting of the first sound element is adjusted in response to the input signal.

8. The visual sound effect adjustment method according to claim 4, wherein the user operation interface includes a display screen and a touch pad, and the first representative icon, the first volume setting icon and a cursor of the touch pad are displayed on the display screen, wherein an input signal is generated when the first volume setting icon is operated through the touch pad, and the volume setting of the first sound element is adjusted in response to the input signal.

9. A visual sound effect adjustment method for a computing device, a visual sound effect adjustment program being executed to perform the visual sound effect adjustment method, the visual sound effect adjustment method comprising steps of:
acquiring a first audio signal;
recognizing a first sound element and a second sound element contained in the first audio signal, and displaying a first representative icon and a first volume setting icon corresponding to the first sound element and a second representative icon and a second volume setting icon corresponding to the second sound element;
judging whether a volume setting of the first sound element or a volume setting of the second sound element needs to be adjusted;
capturing a second audio signal after the volume setting of the first sound element or the volume setting of the second sound element is adjusted, and extracting the first sound element and the second sound element from the second audio signal; and
reproducing the second audio signal, and adding the adjusted first sound element or the adjusted second sound element to the second audio signal.

10. The visual sound effect adjustment method according to claim 9, wherein each of the first representative icon and the second representative icon represents a weapon, an equipment, an action, an event, a character, a scene and a musical instrument.

11. The visual sound effect adjustment method according to claim 9, wherein each of the first representative icon and the second representative icon is a slider icon or a knob icon.

12. The visual sound effect adjustment method according to claim 9, wherein the first representative icon, the first volume setting icon, the second representative icon and the second volume setting icon are displayed on a user operation interface.

13. The visual sound effect adjustment method according to claim 12, wherein the user operation interface includes a touch screen, and a touch signal is generated when the first volume setting icon or the second volume setting icon is operated through the touch screen, wherein the volume setting of the first sound element or the volume setting of the second sound element is adjusted in response to the touch signal.

14. The visual sound effect adjustment method according to claim 13, wherein the touch screen is a display screen of a notebook computer, a display screen of a tablet computer, a display screen of a mobile phone or a display screen of an audio control device.

15. The visual sound effect adjustment method according to claim 12, wherein the user operation interface includes a display screen and a mouse, and the first representative icon, the first volume setting icon and a cursor of the mouse are displayed on the display screen, wherein an input signal is generated when the first volume setting icon or the second volume setting icon is operated through the mouse, and the volume setting of the first sound element or the second volume setting icon is adjusted in response to the input signal.

16. The visual sound effect adjustment method according to claim 12, wherein the user operation interface includes a display screen and a touch pad, and the first representative icon, the first volume setting icon, the second representative icon, the second volume setting icon and a cursor of the touch pad are displayed on the display screen, wherein an input signal is generated when the first volume setting icon or the second volume setting icon is operated through the touch pad, and the volume setting of the first sound element or the volume setting of the second sound element is adjusted in response to the input signal.

17. A visual sound effect adjustment method for a computing device, a visual sound effect adjustment program being executed to perform the visual sound effect adjustment method, the visual sound effect adjustment method comprising steps of:
acquiring a first audio signal;
recognizing a first sound element and a second sound element contained in the first audio signal;
recognizing a usage scenario containing the first sound element and the second sound element; and
displaying a representative icon corresponding to the usage scenario.

18. The visual sound effect adjustment method according to claim 17, wherein the representative icon is a pattern, a text, or a combination thereof.

19. The visual sound effect adjustment method according to claim 17, wherein a type of the usage scenario is a music, a movie or a video game.

20. The visual sound effect adjustment method according to claim 19, wherein the video game is a shooting game, an action game, a fighting game, an adventure game, a role-playing game, a strategy game, a simulation game, a racing game, a sports game, a music game or a puzzle game.

21. A visual sound effect adjustment method for a computing device, a visual sound effect adjustment program being executed to perform the visual sound effect adjustment method, the visual sound effect adjustment method comprising steps of:
outputting a first audio signal and a first screen image, wherein the first audio signal contains a first sound element;
displaying a first representative icon and a first volume setting icon corresponding to the first sound element on the first screen image;
judging whether a volume setting of the first sound element needs to be adjusted; and
outputting a second audio signal and a second screen image after the volume setting of the first sound element is adjusted, wherein the second audio signal contains the first sound element, and the first sound element is outputted according to the adjusted volume setting when the second audio signal is outputted.

22. The visual sound effect adjustment method according to claim 21, wherein the first representative icon represents a weapon, an equipment, an action, an event, a character, a scene and a musical instrument.

23. The visual sound effect adjustment method according to claim 21, wherein the first volume setting icon is a slider icon or a knob icon.

24. The visual sound effect adjustment method according to claim 21, wherein the first representative icon and the first volume setting icon are displayed on a user operation interface.

25. The visual sound effect adjustment method according to claim 24, wherein the user operation interface includes a touch screen, and a touch signal is generated when the first volume setting icon is operated through the touch screen, wherein the volume setting of the first sound element is adjusted in response to the touch signal.

26. The visual sound effect adjustment method according to claim 25, wherein the touch screen is a display screen of a notebook computer, a display screen of a tablet computer, a display screen of a mobile phone or a display screen of an audio control device.

27. The visual sound effect adjustment method according to claim 24, wherein the user operation interface includes a display screen and a mouse, and the first representative icon, the first volume setting icon and a cursor of the mouse are displayed on the display screen, wherein an input signal is generated when the first volume setting icon is operated through the mouse, and the volume setting of the first sound element is adjusted in response to the input signal.

28. The visual sound effect adjustment method according to claim 24, wherein the user operation interface includes a display screen and a touch pad, and the first representative icon, the first volume setting icon and a cursor of the touch pad are displayed on the display screen, wherein an input signal is generated when the first volume setting icon is operated through the touch pad, and the volume setting of the first sound element is adjusted in response to the input signal.
